(19) United States
(12) Patent Application Publication
(10) Pub. No.: US 2006/0084750 A1
(43) Pub. Date: Apr. 20, 2006

(54) Compression moldable composite bipolar plates with high through-plane conductivity

(76) Inventors: Jianhua Huang, Blacksburg, VA (US); Donald G. Baird, Blacksburg, VA (US); James E. McGrath, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/244,401

(22) Filed: Oct. 6, 2005

Related U.S. Application Data
(63) Continuation-in-part of application No. 10/779,804, filed on Feb. 18, 2004.
(60) Provisional application No. 60/447,727, filed on Feb. 19, 2003.

(51) Int. Cl. C08K 3/04

(52) U.S. Cl. 524/495

(57) ABSTRACT

A low cost method of fabricating bipolar plates for use in fuel cells utilizes a wet lay process for combining graphite particles, thermoplastic fibers, and reinforcing fibers to produce a plurality of formable sheets. The formable sheets are sandwiched between outer layers consisting of polymer and graphite particles, then molded into a bipolar plates with features impressed therein via the molding process. The bipolar plates formed by the process have sufficient mechanical strength and bulk conductivity to be used in fuel cells The outer layers provide for enhanced conductivity and resistance to gas permeation.

### CROSS-REFERENCE TO RELATED APPLICATIONS

This application is a continuation-in-part of U.S. patent application Ser. No. 10/779,804 filed Feb. 18, 2004, which claims priority to U.S. Provisional Patent Application Ser. No. 60/447,727 filed Feb. 19, 2003, and the complete contents of both applications are herein incorporated by reference.

### STATEMENT OF GOVERNMENT INTEREST

This invention was made with government support under Contract Number DE-AC05-00OR22725 awarded by the U.S. Department of Energy. The Government has certain rights in the invention.

### DESCRIPTION

### BACKGROUND OF THE INVENTION

1. Field of the Invention

The present invention generally relates to highly conductive thermoplastic composites intended for the rapid and economical production of fuel cell bipolar plates, and the method for making the same.

2. Background Description

Bipolar plate materials have historically been metals coated with corrosion resistant layers or graphite with a seal treatment to lower the gas permeability. In both cases, the bipolar plates require extensive machining and post processing, resulting in hardware costs far more expensive than the costs for the raw materials alone. To date, the costs of bipolar plates dominate the stack costs. Unless bipolar plates that are considerably less expensive are developed, PEM (Proton Exchange Membrane) fuel cells cannot easily be applied to civilian markets to compete with established power technology.

As one of the key and costly components of PEM fuel cells, the bipolar plates must have high electrical conductivity, sufficient mechanical integrity, corrosion resistance, low gas permeability, and low-cost in both materials and processing when applied to the civilian market. To replace graphite bipolar plates and lower the cost, a variety of composite bipolar plates have been developed. Most of them were made by compression molding of a polymer matrix (thermoplastic or thermoset resins) filled with conductive particles (such as graphite powders) or fibers. Because most polymers have extremely low electronic conductivity, excessive conductive fillers have to be incorporated, and it is very difficult to get high conductivity and sufficient mechanical properties at the same time. To solve this problem, Oak Ridge National Laboratory (ORNL) recently developed carbon/carbon composite bipolar plates. The manufacturing process consists of multiple steps, including the production of carbon fiber/phenolic resin preforms (by slurry-molding or wet-lay process) followed by compression molding, and the pyrolysis and densification on surface by a chemical vapor infiltration (CVI) process. The plates have high conductivity (about 200-300 S/cm). However, this process is too complicated and is by no means economic.

While polymer composite bipolar plates under development may have many advantages over the traditional graphite or metallic plates, it is a challenge to make a composite plate with both high electrical conductivity and adequate mechanical properties. U.S. Pat. No. 5,614,312 to Tucker et al, incorporated herein by reference, teaches a process for producing graphite-filled (up to 55%) wet-lay sheet materials, as well as composite plaques as thermally and electrically conductive materials. However, the composite materials did not have adequate electrical conductivity, especially in the through-plane direction. On the other hand, U.S. Pat. No. 4,214,969 to Lawrance disclosed compression moldable composite bipolar plates with fluoropolymer and graphite mixtures. The composite had inadequate mechanical properties when graphite particles were incorporated in excess of 70%, which is the amount necessary to achieve high electrical conductivity.

### SUMMARY OF THE INVENTION

It is, therefore, an object of the present invention to provide highly conductive thermoplastic composites which can be used for rapid production of fuel cell bipolar plates.

It is also an object of the present invention to provide highly conductive thermoplastic composites having a very low half-cell resistance, or through-plane area specific resistance.

It is also an object of the present invention to provide highly conductive thermoplastic composites having mechanical properties sufficient for use in fuel cell bipolar plates.

According to the invention, economical fuel cell bipolar plates that have high electrical conductivity and good mechanical properties are produced. The core of the composite comprises thermoplastic fibers, such as polyester or polyphenylene sulfide fibers, graphite particles, and carbon or glass fibers, and is produced by a wet-lay process to yield highly formable sheets. The outer layers of the composite are comprised of polymer, such as fluropolymer, and graphite particles. The porous sheets are stacked and sandwiched between the outer layers, and finally compression molded to form bipolar plates with gas flow channels and other features. In the preferred embodiment, the substitution of polymer and graphite powder in a sandwich structure for the wet-lay composites promotes the orientation of graphite particles in the through-plane direction during the compression molding process, leading to higher through-plane conductivity, or lower half-cell resistance, of the bipolar plate. Further, the glass or carbon fiber reinforces the strength and stiffness of the core of the bipolar plate, while the polymer (e.g., fluoropolymer) and graphite in the outer layers serve as a barrier to hydrogen, oxygen, water, and corrosive chemicals.

Plates containing 65 wt % graphite in the core had a bulk conductivity over 200 S/cm, well exceeding the Department of Energy (DOE) target (100 S/cm) for composite bipolar plates. This value of conductivity is also the highest of all polymer composites with the same or similar graphite loadings, reaching the range of carbon/carbon composite bipolar plates (200-300 S/cm) as reported by the Oak Ridge National Laboratory and Porvair Fuel Cell Technology (see Haack, “Fuel Cell Technology: Opportunities and Challenges”, Topical Conference Proceedings, 2002 AICheE Spring National Meeting, Mar. 10-14, 2002, pp. 454-459). The tensile strength and modulus of composites produced by this method are 36.5 MPa and 12.6 GPa, respectively. The half-cell resistance of composites produced by this method is 0.010 Ohm-cm², which is only half of the value required for use in automobiles. Because the plates can be generated without high temperature pyrolysis (for carbonization) and chemical vapor infiltration (for densification), they can be manufactured at much less cost compared to the carbon/carbon plates.

Plates containing 70 wt % graphite, 23 wt % PET, 6 wt % carbon fiber, and 1 wt % microglass in the core, sandwiched between outer layers of 20 wt % fluoropolymer and 80 wt % graphite, had a tensile strength and modulus of 32.0 MPa and 10.8 GPa, respectively, and a flexural strength and modulus of 46.3 MPa and 6.3 GPa, respectively. Plates containing 80 wt % graphite, 16 wt % PET, 3 wt % carbon fiber, and 1 wt % microglass in the core, sandwiched between outer layers of 20 wt % fluoropolymer and 80 wt % graphite, had a tensile strength and modulus of 32.0 MPa and 17.3 GPa, respectively, and a flexural strength and modulus of 46.3 MPa and 6.3 GPa, respectively.

In a preferred embodiment, the fuel cell plates will have stamped or ribbed pattern on their surface and will be fabricated from a composite material, comprising: 60-80 wt % graphite particles, thermoplastic at 10 to 30 wt %, and reinforcing fibers at 1 to 20 wt %. The composite material will also have one or more of the following attributes: bulk conductivity is at least 150 S/cm, through-plane conductivity of at least 10 S/cm, or half cell resistance ranging from 0.03 to 0.003 ohm-cm²

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic drawing of a wet-lay process used for generating the composite sheets used in the manufacture of bipolar plates;

FIG. 2 is a graph showing the conductivity of wet-lay and wet/dry composite materials;

FIG. 3 is a bar graph showing the tensile properties of compression molded wet/lay and wet/dry lay composites;

FIG. 4 is a bar graph showing the flexural properties of compression molded wet-lay and wet/dry lay composites;

FIG. 5 is a photograph of a compression molded bipolar plate with wet/dry lay materials;

FIG. 6 is a graph showing the electrical conductivity of laminate composite materials;

FIG. 7 is a bar graph showing the tensile properties of compression molded laminate composite materials; and

FIG. 8 is a bar graph showing the flexural properties of compression molded laminate composites.

FIG. 9 is a drawing of a device to measure through-plane conductivity in a bipolar plate.

FIG. 10 is a bar graph showing the through-plane conductivity of compression molded laminate composites.

FIG. 11 is a cross-sectional drawing of compression molded laminate composites.

### DETAILED DESCRIPTION OF A PREFERRED EMBODIMENT OF THE INVENTION

The invention provides a method for producing economical bipolar plates with high bulk electrical conductivity, high through-plane conductivity, and adequate mechanical properties, for use in fuel cells. The composite comprises graphite particles which may be natural or synthetic and are preferably of a size ranging from −35/+100 Tyler mesh size; thermoplastic fibers which preferably are fine (about 0.5 to 20 denier) and have a length of about 1 to 5 cm (and may have a surface treated with a dispersing aid); and reinforcing fibers which are preferably of a size ranging from 20 microns to 1.5 inches. The graphite particles serve the function of providing electrical conductivity and are preferably present in the composite at a weight percentage (wt %) of 50 to 90 wt % and most preferably 65 to 85 wt %). The thermoplastic fibers serve the function of melting and adhering to the carbon or glass fibers and solidifying to form a mat or sheet material with the carbon or glass or ceramic fibers held together with the graphite particles impregnated in the thermoplastic and adhering to the mat. The thermoplastic fibers are preferably present at 20-50 wt %, and most preferably at 30-45 wt %. The choice of thermoplastic fibers can vary widely depending on the application, and suitable examples are polyesters, polyamides (e.g. nylon 6, 66, 11, 12, 612 and high temperature nylons such as nylon 46), polypropylene, copolyetheresters, polyethylene terephthalates, polybutylene terephthalate, polyetheretherketones, polyeetherketoneketones, and liquid crystalline polymer fibers, and mixtures thereof. Examples of suitable reinforcing fibers include but are not limited to glass fibers, carbon fibers, metal fibers, polyaramid fibers (e.g., Kevlar®), and metal whiskers. Glass and carbon fibers are preferred for use as the reinforcing fibers, and the reinforcing fibers provide structural rigidity to the mat or sheet material and the composite which is ultimately produced. The reinforcing fibers are preferably present at 5-15 wt %. The composite is sandwiched between outer layers comprised of polymer, such as fluoropolymer; and graphite particles which may be natural or synthetic and are preferably of a size ranging from −35/+100 Tyler mesh size. An example of fluoropolymer is polyvinylidene fluoride (Kynar®), which has a melting point of about 177° C. and, therefore, requires less heat during compression molding to form features such as gas flow channels than materials such as PET, which has a melting point of about 260° C. Additionally, the polymer in the outer layers serves the function of both promoting the orientation of graphite particles in the through plane direction during compression molding and also acting as a barrier to hydrogen, oxygen, water, and corrosive chemicals.

The composite is preferably formed from a plurality of fibrous mats or sheet materials, each of which are made by a wet-lay process which yields highly formable sheets. A number of wet-lay processes could be used in the practice of this invention. An example of a suitable wet-lay process for forming sheet materials is described in U.S. Pat. No. 5,614,312 to Tucker et al., which is herein incorporated by reference. The sheets, preferably together with additional graphite particles, are then stacked, sandwiched between outer layers comprised of a mixture of polymer and graphite particles, and finally compression molded to form bipolar plates with gas flow channels and other features. The ratio of polymer and graphite powder/wet-lay sheets/polymer and graphite powder is preferably 1:1:1. In particular, the sheets can have additional graphite powder sprayed, poured, or otherwise deposited on their surfaces prior to being stacked together as well as on the top and bottom of the stack, such that upon molding, the molded bipolar plate includes a suitable amount of graphite powder.

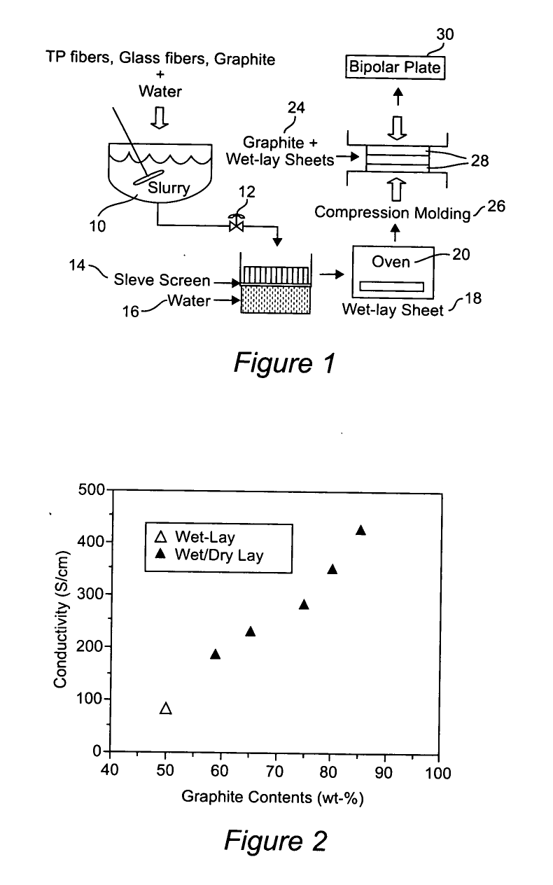

FIG. 1 illustrates a wet lay process which may be used within the practice of the present invention. First, polymer fibers, such as PET or thermotropic liquid crystalline polymers as noted in U.S. Pat. No. 5,614,312 to Tucker, reinforcing fibers such as glass fibers, and graphite particles are combined with water to form a slurry 10. The slurry 10 is pumped by pump 12 and deposited on a sieve screen 14. The sieve screen 14 is preferably a moving conveyor belt, and serves the function of separating the water 16 from the polymer fibers, glass fibers and graphite. The polymer fibers, reinforcing fibers and graphite form a wet lay sheet 18 which is placed in or conveyed through an oven 20. Upon heating to a temperature sufficient to melt the polymer fibers, the wet lay sheet 18 is permitted to cool and have the polymer material solidify. Upon solidification, the wet lay sheet takes the form of a sheet material with glass reinforcing fibers held together by globules of polymer material, and graphite particles adhered to the sheet material by the polymer material. Several of these sheets are then stacked 24, preferably with additional graphite powder interspersed between sheets, and compression molded in press 26. In the preferred embodiment, the stacked sheets 24 are sandwiched between at least one outer layer of polymer and graphite particles 28. After application of heat and pressure in the press 22, one or more formed bipolar plates 30 are obtained, where the bipolar plates are a composite of glass fibers, polymer matrix and graphite particles, preferably sandwiched between at least one outer layer of polymer and graphite particles. These bipolar plates have sufficient bulk electrical conductivity, through-plane conductivity, mechanical integrity, corrosion resistance, and low gas permeability to be useful in PEM fuel cell applications. Further, it has also been found that the conductivity and resistance to gas permeation can be improved by using a skin/core laminate where the skin of the composite is made using a polymer material different from the core (e.g., a polyvinyldifluoride (PVDF)) without adversely impacting the mechanical properties of the bipolar plates. The choice of polymeric material can vary depending on the application. The laminate design of this invention can allow a central core of the bipolar plate to have enhanced mechanical stability, while an outer skin has enhanced conductivity (which can be increased by adding graphite powder to the skin prior to compressing the stack) and increased resistance to gas permeability.

For comparison purposes, conductivity of the bipolar plates produced by the above-described method was compared against polymer composites of similar graphite loading. Table 1 presents the results of this comparison.

TABLE 1
Bulk conductivity of polymer composites for bipolar plates

| | | wt % Filler | Conductivity | |
|---|---|---|---|---|
| Matrix | Filler | Content | (S/cm) | Reference |
| Epoxy | graphite | 70 | 10-30 | F. Jouse¹ |
| Phenolic resin | graphite | 77.5 | 53 | U.S. Pat. No. |
| | | | | 5,942,347 |
| Fluoropolymer | graphite | 74 | 119 | U.S. Pat. No. |
| | | | | 4,214,969 |
| Fluoropolymer | graphite | 74 | 109 | U.S. Pat. No. |
| | & CF | | | 4,339,322 |
| Vinyl ester | graphite | 68 | 85 | U.S. Pat. No. |
| | | | | 6,248,467 |
| Thermoplastics | graphite | 65 | 230-250 | present work |
| (polyester) | | | | |

Furthermore, many of the prior processes yield bipolar plates with inadequate or non-optimal mechanical properties. For example, the flexural and tensile strengths (in MPa) for vinyl ester/graphite composites as described in U.S. Pat. No. 6,248,467, and commercial variants thereof available from Premix, Inc. and BMC, Inc., as well as the results reported by Clulow et al. “Development of Vinyl Ester/Graphite Composite Bipolar Plates” in Fuel Cell Technology: Opportunities and Challenges Topical Conference Proceedings, 2002 AIChE Spring National Meeting, Mar. 10-14, 2002, pp. 417-425, ranged from 28.2 MPa to 40 MPa for flexural strength, and from 23.4 to 26.2 MPa for tensile strength. The fluoropolymer and graphite composite described in U.S. Pat. No. 4,214,969 had a flexural strength ranging from 35.1 to 37.2 MPa, and the fluoropolymer, graphite and carbon fiber matrix of U.S. Pat. No. 4,339,322 had a flexural strength of 42.7 MPa. By contrast, the bipolar plates made by the present invention had a flexural strength of 53.0±2.35 MPa and a tensile strength of 36.5±2.06 MPa. Compared to the ORNL technology, the technology of the present invention can produce quality bipolar plates (with the same conductivity) at much lower cost. In particular, no chemical vapor infiltration (CVI) process or pyrolysis process is involved which represents over 70% of total cost of C/C plates. Thus, the invention has great commercial value and should allow the viable, private sector commercialization of the fuel cell technology.

In the practice of this invention it is preferred to craft a bipolar plate with a bulk conductivity in excess of 150 S/cm, which has sufficient mechanical strength and resistance to degradation to allow use in the fuel cell environment. In the bipolar plate, the thermoplastic is present as a matrix, having been derived from melting fibers and then re-solidifying, and the graphite powder is dispersed throughout the plate and at its surfaces, and may be more concentrated in a skin polymer. Further, the reinforcing fibers are distributed throughout the plate, and may be concentrated in the core rather than in a skin polymer if a laminate structure is produced. Having a flexural strength in excess of 45 MPa and preferably in excess of 50 MPa is preferred. Having a tensile strength in excess of 30 MPa and preferably in excess of 35 MPa is preferred. Using a skin polymer can provide enhanced resistance to gas permeability and also allow for enhanced conductivity, particularly if the skin includes additional graphite particles. Bipolar plates which can be used in fuel cells can be cost effectively molded, using either compression molding or a suitable alternative, from a set of stacked sheet materials formed from a wet lay process that combines the graphite, thermoplastic, and reinforcing fibers into mats, where the mats can be stacked and accept features such as guides and the like being formed during the molding process.

### EXAMPLE 1

Wet-lay sheets made from 50 wt % graphite particles, 40 wt % polyester fibers and 10 wt % glass fibers were donated by DuPont. Polyester may or may not be an ideal matrix for application in fuel cell environment, but use of this material in no way impaired testing the concept. In fact, the wet-lay sheet can be generated with almost any thermoplastic fibers, including thermotropic liquid crystalline polymer (TLCP) fibers. TLCPs are known as excellent matrices for fuel cell applications. The graphite powder that was added in the compression molding step was TIMREX provided by Timcal America Inc.

The sheet materials were cut according to the mold size and stacked together with additional graphite powders in the mold. The assembly was placed in a hydraulic press and pressed at 277° C. and 900˜1500 psi for 10 minutes. Then the platen heaters were turned off and the mold was allowed to cool. The pressure was maintained until the mold temperature reached 200° C. The pressure was then allowed to drop as mold temperature deceased further. When the mold temperature reached 30° C., the platens were opened and the assembly was removed from the press. The flat plaque or bipolar plate with gas flow channels was then removed from the mold.

The bulk conductivities (in-plane) were measured using the van der Pauw method according to ASTM Standard F76-86. The typical size of the specimens is 25.4 mm in diameter and 1˜2 mm in thickness. The sheet resistance, R_{S}, was obtained from the two measured characteristic resistances R_{A} and R_{B} by numerically solving the van der Pauw equation:
exp(−ΠR_{A}/R_{S})+exp(−ΠR_{B}/R_{S})=1
The resistivity is given by=R_{S}d, where d is the thickness of the specimen. The volume conductivity σ=1/ρ.

The tensile and flexural (three-point bending) tests were performed at room temperature (23° C.) on an Instron 4204 tester in accordance with ASTM D638 and D790 standards, respectively. The specimen sizes were of L(Length)×W(Width)=76.2×7.7 mm for the tensile test, and L×W=76.2×12.7 mm for the flexural test. The thickness of the samples was about 2 mm.

FIG. 2 presents the bulk conductivities (in-plane) of compression-molded plaques using wet-lay sheets (wet-lay material) or wet-lay sheets plus additional graphite (wet/dry lay material). It was noted that the graphite content of the wet/dry lay materials could reach 85 wt %, which is much higher than what the wet-lay sheets could hold as described in Tucker et al., U.S. Pat. No. 5,614,312. As the graphite content increases, a significant increase in bulk conductivity was observed. Because the composites with graphite higher than 75% may have poor mechanical properties, further research was focused on the material with 65% graphite.

The bulk conductivities (in-plane) of wet/dry (W/D) lay material and other state-of-the-art composite materials for bipolar plates are listed above in Table 1. The plates containing 65 wt % graphite have a bulk conductivity of over 200 S/cm, well exceeding the DOE target (100 S/cm) for composite bipolar plates. This value of conductivity is also the highest of all polymer composites with the same or similar graphite loadings, reaching the range of carbon/carbon composite bipolar plates (200˜300 S/cm) developed by the Oak Ridge National Laboratory and Porvair Fuel Cell Technology. The inventive technology described herein involves no pyrolysis and CVI processes which represent over 70% of total cost of cabon/carbon (C/C) plates (see Besmann, J. Electrochem. Soc. 147:4083-4086 (2000)), and it should be possible to manufacture the plates at much less cost compared to the C/C plates.

In addition to the electrical conductivity, the bipolar plates should also have adequate mechanical properties to be applied in the fuel cell stacks. However, for polymer composites doped with conductive particles or fibers, it is difficult to get high conductivity and sufficient mechanical properties at the same time. Compared to the mechanical properties of wet/dry (W/D) lay material and other composite plates, the flexural and tensile strengths of W/D lay composite are 53.0 MPa and 36.5 MPa, respectively. Both are the highest in all polymer composite plates with the same or similar graphite loadings. It is noted that Besmann et al. reported a flexural strength of 175 MPa for their carbon/carbon plates. However, because the property was obtained by means of a biaxial flexure test, not the standard three-point flexure as defined by ASTM D790, it is difficult to compare their results with the strength data found for the present materials.

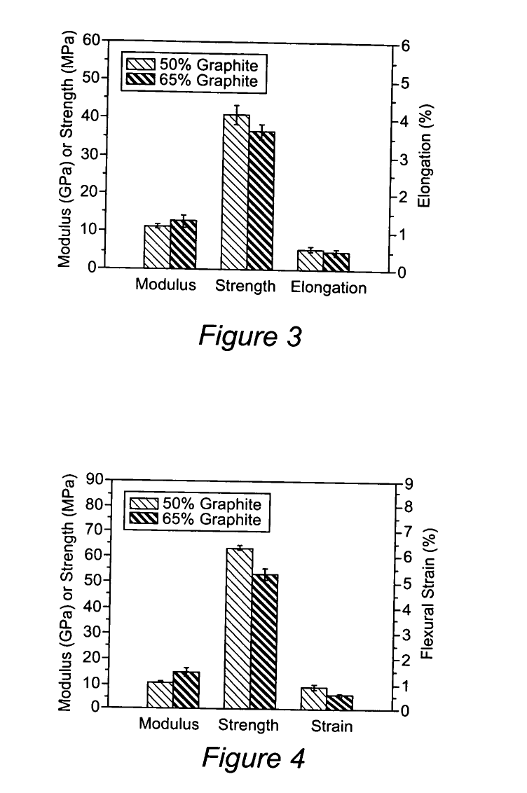

It is apparent that the mechanical properties of the wet/dry lay material have a close relation with the structure of the wet-lay sheet materials. It has been shown that compression molded wet-lay material has excellent mechanical properties in U.S. Pat. No. 5,614,312 to Tucker, which is herein incorporated by reference. This is believed to be the result of the unique structure of the wet-lay sheets, including the interaction of the reinforcing fibers and the layered structures formed in the slurry making process. FIGS. 3 and 4 present the mechanical properties of wet/dry lay materials as compared to the wet-lay materials (containing 50 wt % graphite). As graphite content increases from 50 wt % to 65 wt %, the modulus of the material increases, which can be attributed to the addition of graphite powder which has a modulus significantly higher than that of the matrix (polyester). In contrast, the strength and maximum strain decrease in both tensile and flexural tests. This may also be attributed to the addition of graphite powder that acts like defects in the polymer matrix when the composite undergoes a tensile or flexural test. The loss of tensile or flexural strength in W/D lay composites may also be caused by the decrease of glass fiber contents after more graphite (in addition to that contained in the wet-lay materials) is added. In fact, W/D lay material containing 65% graphite has only 7 wt % glass, which is less than original wet-lay material (10 wt %) by 30%. Nevertheless, as can be seen from FIGS. 3 and 4, W/D lay composites in this experiment still have 89% tensile strength and 84% flexural strength relative to the wet-lay materials. That is, the W/D lay materials containing 65% graphite still retain the good mechanical properties offered by the reinforcing fibers and layered structures in the wet-lay sheets.

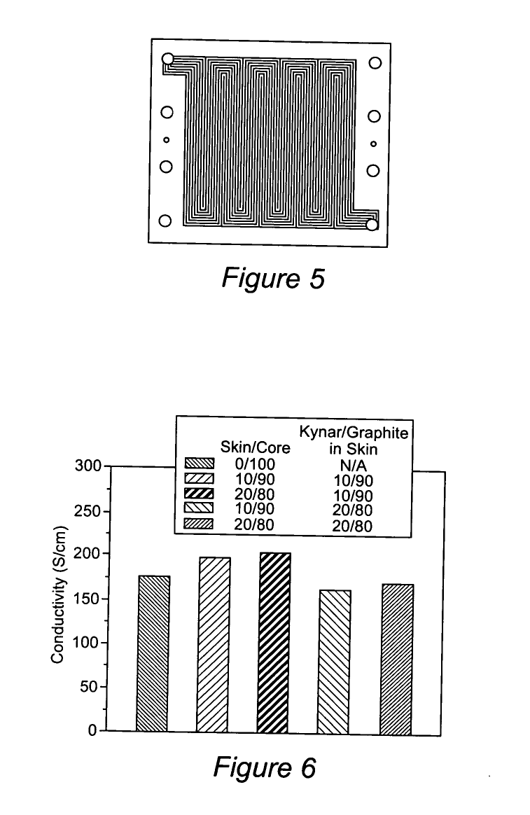

For all composite materials for bipolar plates, the formability of the material is very important if the gas flow channels are to be readily formed during a molding process. This is because the flow channels in bipolar plates are numerous (i.e. densely spaced), narrow and relatively deep, e.g. 0.8 mm or 1/32 inch in width and depth. For composite containing stacks of wet-lay mats, experiments were conducted to determine whether the material is deformable enough to allow the formation of the channels and other features of bipolar plates as required during compression molding. If not, the flow channels would have to be machined and the advantages of polymer composites would vanish. To evaluate the formability of the wet/dry lay composite, a mold was made with a few straight grooves based on a standard bipolar plate design (7-channel, Los Alamos National Laboratory) and this mold was used in the compression molding. The results showed that the composite has good formability, and the flow channels (simplified) formed are as good as other composite systems. On this basis, a standard mold was designed and fabricated for making the composite bipolar plates. FIG. 5 presents a bipolar plate generated with this mold and wet/dry lay materials. It can be seen that the composites are highly formable and complicated flow channels and other features of the bipolar plates can be readily generated by compression molding.

### EXAMPLE 2

Due to the hydrolysis of polyethylene terephthalate (PET) in the presence of water and elevated temperature, there may be disadvantages to using this material in PEM fuel cells. However, PET provides for high electrical conductivity, good mechanical properties, and low cost. Therefore, a skin-core or laminate composite structure may be preferable for making bipolar plates for use in PEM fuel cells. Because the bipolar plate has skin and core layers, the polymers that cannot serve as matrix of bipolar plate in whole may become an ideal matrix for the skin or core layers only.

Experiments were conducted to demonstrate the possibility of taking advantage of PET as a binder of bipolar plate with no hydrolytic degradation concern. More specifically, the composite sheets consisting of graphite particles, polyester and glass fibers are first generated by means of a wet-lay process as described in Example 1. The porous sheets are then stacked with additional graphite particles and covered with a mixture of fluoropolymer and graphite particles and compression molded to form layered composite bipolar plates with gas flow channels. In such laminate bipolar plates, the low-cost polyester and glass in the core contribute strength and stiffness while the fluoropolymer in the outer layer provides an excellent barrier to H₂, O₂, water and corrosive chemicals. As a result, the new bipolar plates have not only low cost and high electrical and mechanical properties, but also excellent chemical resistance.

The methods employed in Example 1 were repeated herein. In addition, the bulk conductivities, resistivity, and tensile and flexural (three-point bending) tests were performed as discussed in Example 1.

Starting with the selection of polymer resins for skin layers of laminate bipolar plates, the polymer should meet a number of requirements, including excellent chemical resistance, being moldable at temperature matching that of PET (because the PET-based wet-lay material is used in the core), excellent electrical conductivity after doped with graphite fillers, and formation of composite with good adhesion in interfaces. Considering that Poly(vinylidene fluoride) (PVDF) has excellent chemical resistance and electrical conductivity when doped with excessive graphite particles, as well as broad processing temperature range (from 175° C. to above 300° C.) that overlaps with the molding temperature of PET, Kynar 761, a powder form of PVDF produced by Atofina Chemicals, was chosen as the binder in skin layers.

The processing and compression molding conditions for laminate bipolar plates are basically the same as the wet/dry lay composite plates as was described previously, except for that in the top and bottom layers a mixture of Kynar 761 and graphite powders were used to form protective (skin) layers. More specifically, the composite comprising graphite particles, thermoplastic (PET) fibers and carbon or glass fibers is generated by means of a wet-lay process to yield highly formable sheets. The sheets together with additional graphite particles are then stacked, covered with the mixture of fluoropolymer and graphite particles, and compression molded at about 277° C. to form bipolar plates with gas flow channels and other features.

It is desired that such laminate composite bipolar plates have not only improved chemical resistance, but also excellent electrical conductivity and mechanical properties as was observed for wet/dry lay composite materials (that is, the core materials here). FIG. 6 presents the bulk conductivities (in-plane) of compression-molded composite plaques with and without skin layers. It can be seen that the laminate composites have the same or even higher (when skin layer contains 90% of graphite) conductivity as compared to the core material which contains 65% graphite only. All of the composite materials have electrical conductivity higher than that of the DOE target (100 S/cm) for composite bipolar plates.

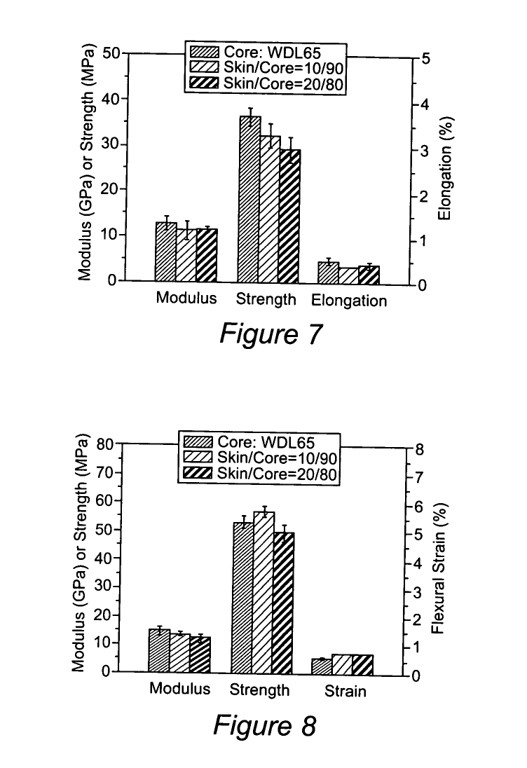

In addition to the electrical conductivity, the bipolar plates should also have adequate mechanical properties to be applied in the fuel cell stacks. However, for polymer composites doped with conductive particles or fibers, it is difficult to get high conductivity and sufficient mechanical properties at the same time. FIGS. 7 and 8 present the mechanical properties of wet/dry lay material with and without skin layers. As was noted in Example 1, the wet/dry materials have the flexural and tensile strengths of 53.0 MPa and 36.5 MPa, respectively, representing the best of all polymer composite plates with the same or similar graphite loadings. Because the skin layers consisting of PVDF and graphite are not as strong as the PET based wet/dry lay materials (core material), it is expected that the mechanical properties of laminate composites would be somewhat lower than the wet/dry lay materials. This change was observed in our tensile experiment as shown in FIG. 7. The loss in tensile strength is, however, not serious according to the test. This is also expected because the proportion of skin layers is only 10 or 20% of the whole plate. In contrast to the tensile behavior, the laminate composites did not lose flexural strength as the skin layer was added (see FIG. 8). It is thus concluded that, the addition of 10 to 20% skin layers has only minor, if any, influence on the mechanical properties of wet/dry lay materials.

The advantage of this laminate structure can also be seen when it is compared to the material consisting of PVDF (Kynar®) and graphite (the same components used in the skin layers). In Table 2 are presented the electrical and mechanical (flexural) properties for these two kinds of materials.

TABLE 2
Property comparison for composite bipolar plates

| | | Conduc- | Flexural | |
|---|---|---|---|---|
| | | tivity | strength | |
| Binders | Fillers, wt % | (S/cm) | (MPa) | Source |
| PVDF | 74% graphite | 119 | 37.2 | U.S. Pat. No. |
| | | | | 4,214,969 |
| PVDF | 74% graphite and CF | 109 | 42.7 | U.S. Pat. No. |
| | | | | 4,339,322 |
| PVDF + | 66.5% graphite | 171 | 60.2 | This invention |
| PET | skin/core = 10/90; | | | |
| | PVDF/graphite = 20/80 | | | |
| PVDF + | 68% graphite | 163 | 54.4 | This invention |
| PET | skin/core = 20/80, | | | |
| | PVDF/graphite = 20/80 | | | |

The PVDF/graphite composite developed by GE has electrical conductivity of 119 S/cm and flexural strength of 37.2 MPa. After carbon fiber was added as reinforcement, the flexural strength rose to 42.7 MPa while electrical conductivity degraded to 109 S/cm. In comparison, the laminate composites of the present invention have much better performance in both electrical conductivity and mechanical properties. In addition, the laminate composites have lower raw material cost as the price of PET is much lower than that of PVDF.

Compression molded bipolar plates, similar to that described in Example 1 and shown in FIG. 5, were made in a similar manner with similar results from the skin/core material described in Example 2.

### EXAMPLE 3

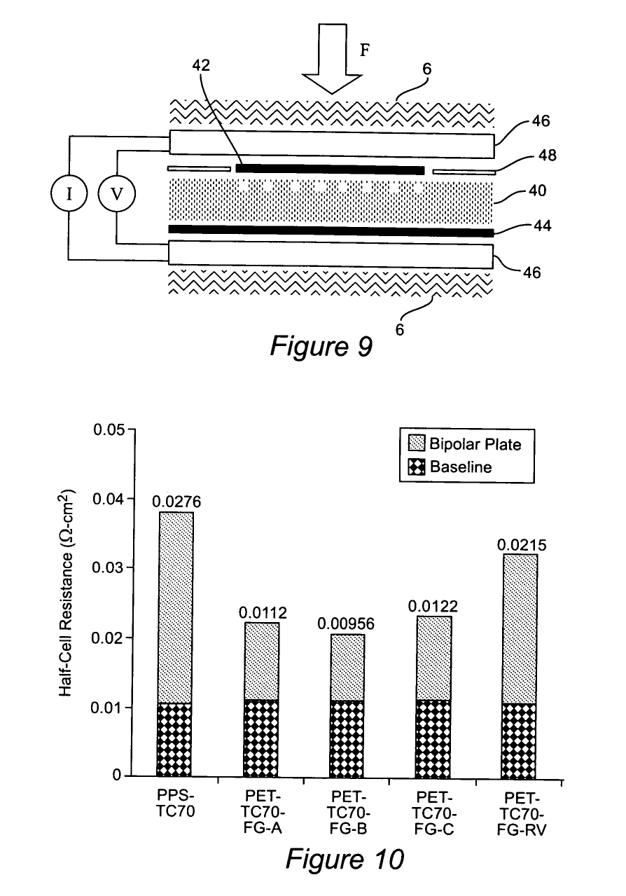

A device as shown in FIG. 9 was used to measure half-cell resistance for various composite bipolar plates. A single-sided bipolar plate (i.e., a plate with channels molded on only one side), having dimensions L×W×H 12.1×14.0×0.32 cm and an active area of 100 cm² 40 was placed between two pieces of carbon paper TORAY TGP-H-120 42 and 44. Carbon paper 42 was L×W 10×10 cm, positioned on the channel side of the bipolar plate 40, and carbon paper 44 was L×W 12.1×14.0 cm, positioned on the on the flat, non-channeled side of the bipolar plate 40. The side of each piece of carbon paper 42 and 44 not in contact with the single-sided bipolar plate 40 was in contact with a gold-plated copper plate 46 used as a current collector. Gaskets 48 were used to maintain the position carbon paper 42 over the channeled region of the bipolar plate 40. Insulating layers 50 were placed above and below the device.

While a constant current, typically 250 mA, was passed through the gold current collectors 46, the potential drop between the collectors was measured. The half-cell resistance was then calculated based on Ohm's law. The measurements were made with a one-ton or 1.0 MPa (145 psi) load F on the channel side, which is a typical clamp pressure used in the actual PEM fuel cell stacks. The resistance baseline, which is the resistance of the testing circuit excluding the bipolar plate 40 but including carbon papers 42 and 44, and current collectors 46, was measured immediately after each testing of the bipolar plate 40. This was done to ensure the stability of the baseline of the instrument and to evaluate the contribution of the bipolar plate to the whole half-cell resistance.

FIG. 10 shows the results of half-cell resistance measurements for various bipolar plates. Each measurement includes the resistance baseline, referred to in the legend as BASELINE. Plate PPS-TC70 is made from polyphenylene sulfide-based wet-lay composite sheets containing 70 wt % graphite particles, 30 wt % thermoplastic fiber (e.g., polyphenylene sulfide), without the preferred sandwich structure of the present invention. Plates PET-TC70/FG-A, B and C are three bipolar plates from different batches produced by the preferred method of sandwiching a stack of wet-lay sheets with outer layers of polymer (e.g., PVDF fluoropolymer such as Kynar®) and graphite. The core of the plates tested included about 70 wt % graphite particles, together with fibers (e.g., polyethylene terephthalate). As seen in FIG. 10, the sandwich structure as described herein reduces the half-cell resistance of bipolar plate to less than half of its original values, reaching the DOE target value of less than 0.020 ohm-cm² for fuel cells in automobile applications.

The use of a mixture of polymer and graphite particles in the rib or channeled parts promotes the orientation of graphite in the through-plane direction during deformation in the compression molding process. This orientation of graphite directly leads to higher through-plane conductivity, or lower half-cell resistance. To demonstrate this, a bipolar plate which has exactly the same composition as PET-TC70/FG-A (or B, C) was fabricated, except the components were sandwiched such that the outer layer was comprised of the wet-lay composite used for the core, instead of the preferred mixture of polymer and graphite powders, to form gas flow channels. FIG. 10 also shows the half-cell resistance of this plate, labeled PET-TC70/FG-RV. The measured half-cell resistance of plate PET-TC70/FG-RV, 0.0215 ohm-cm², is about twice as high as the measured half-cell resistance of plates PET-TC70/FG-A, B and C. These results demonstrate that orienting the graphite in the through-plane direction causes an increase in through-plane conductivity.

### EXAMPLE 4

As discussed above, the wet-lay composite materials have excellent mechanical properties. In comparison, the composites made from mixtures of polymer and graphite powders tend to have much lower mechanical properties. Therefore, it is generally expected that mechanical properties of sandwiched composites should be somewhere between the properties of wet-lay composite and the polymer/graphite composite used for the outer layer, or significantly lower than properties of the wet-lay composite if more than half, by weight, of the plate is composed of the outer layer polymer/graphite composite. However, this is not the case for the sandwich composite bipolar plates according to the present invention.

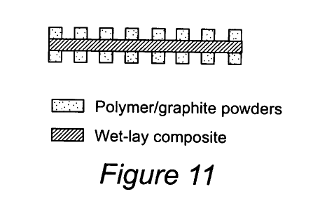

Referring to FIG. 11, the polymer/graphite layers of the sandwich composite bipolar plates of the present invention form “ribs” while the wet-lay composite constitutes the flat core layer. Because the flat core layer, and not the “ribs” determines the tensile or flexural property of the bipolar plates, the mechanical properties of the sandwich bipolar plate should be nearly as good as that of the wet-lay composite plates. It can be seen from the molded sandwich bipolar plates that, although the teeth part may not be as strong as the flat core layer, it is adequate for the plate to go through a demolding process without any damage.

Physical properties were tested for double-sided bipolar plates at different core compositions and outer layer loading levels. Tables 3 and 4 show the tensile strength and modulus, flexural strength and modulus and conductivity for two different core compositions at various outer layer loading levels. An outer layer loading level of 15.5% indicates that the top outer layer constitutes 15.5 wt % of the plate, the bottom outer layer constitutes another 15.5 wt % plate, and the core constitutes the remaining 69 wt % of the plate. A loading level of 0% indicates a base plate with no outer layers of fluoropolymer and graphite. For the plates in Table 3, the core was made from wet-lay sheets containing 70 wt % graphite particles (TC-300), 23 wt % thermoplastic fiber (PET), 6 wt % carbon fiber, and 1 wt % microglass. The outer layers were made from 80 wt % graphite particles (TC-300) and 20 wt % polymer (e.g., PVDF such as Kynar®).

TABLE 3
Physical property comparison for 70 wt % graphite core

| Outer | Tensile | Tensile | Flexural | Flexural | Through-Plane |
|---|---|---|---|---|---|
| Layer | Strength | Modulus | Strength | Modulus | Conductivity |
| Loading | (MPa) | (GPa) | (MPa) | (Gpa) | (S/cm)* |
| 0% | 37.4 | 15.1 | 61.7 | 10.7 | 14.3 |
| 15.5% | 27.6 | 12.8 | 39.7 | 5.6 | 11.4 |
| 19.2% | 31.5 | 10.8 | 46.5 | 6.2 | 12.9 |
| 24.4% | 24.7 | 11.7 | 32.2 | 5.0 | 10.4 |
| 33% | 16.76 | 10.4 | 32.6 | 5.8 | 22.7 |

*conductivity for devices with ribs as shown in FIG. 11

Table 4 shows the tensile strength and modulus, flexural strength and modulus and conductivity for bipolar plates having a core composed of wet-lay sheets containing 80 wt % graphite particles (TC-300), 16 wt % thermoplastic fiber (PET), 3 wt % carbon fiber, and 1 wt % microglass. The outer layers were made from 80 wt % graphite particles (TC-300) and 20 wt % polymer (PVDF such as Kynar®).

TABLE 4
Physical property comparison for 80 wt % graphite core

| | | | | | |
|---|---|---|---|---|---|
| Outer | Tensile | Tensile | Flexural | Flexural | Through-Plane |
| Layer | Strength | Modulus | Strength | Modulus | Conductivity |
| Loading | (MPa) | (GPa) | (MPa) | (Gpa) | (S/cm)* |

| | | | | | |
|---|---|---|---|---|---|
| 0 | 27.6 | 10.7 | 47.0 | 8.78 | 22.1 |
| 15% | 12.3 | 21.4 | 28.4 | 6.94 | 30.3 |
| 20% | 13.2 | 17.3 | 30.2 | 6.29 | 30.1 |
| 25% | 16.0 | 12.8 | 27.4 | 6.62 | 30.1 |
| 33% | 14.4 | 7.97 | 27.8 | 5.68 | 34.5 |

*conductivity for devices as shown in FIG. 11

As expected, the strength of the plates increases as the amount of graphite in the core decreases. Also, conductivity increases as the outer layer loading level increases. It is possible that this trend is the result of a more consistent graphite particle distribution when combined with polymer powder than in the thermoplastic fiber matrix. In a wet-lay process it is likely that graphite particles accumulate unevenly throughout the thermoplastic fiber matrix.

In the practice of this invention, and particularly in fuel cell applications, it is advantageous to have the device have a through plane conductivity of 10 S/cm or more (preferably 20 S/cm or more (e.g., 20-70 S/cm), and to have a half cell resistance ranging from 0.03 ohm-cm² to 0.003 ohm-cm² (preferably less than 0.02 ohm-cm²). The device may be configured from a composite with ribbed polymer/graphite powders, as is shown in FIG. 11, or may assume other configurations (e.g., as shown in FIG. 5

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A method of manufacturing fuel cell bipolar plates, comprising the steps of:
forming a composite material comprising a core formed from graphite particles, thermoplastic fibers, and reinforcing fibers, said composite material having at least one outer layer positioned on said core comprising one or more polymers and graphite particles; and
molding said composite material and said at least one outer layer to form at least one bipolar plate.

2. The method of claim 1 wherein said molding step is performed by compression molding.

3. The method of claim 1 wherein at least one of said one or more polymers in said outer layer is a fluoropolymer.

4. The method of claim 1 wherein said reinforcing fibers are selected from the group consisting of carbon and glass.

5. The method of claim 1 wherein said molding step introduces at least one feature into said bipolar plates.

6. The method of claim 5 wherein said at least one feature is a gas flow channel.

7. The method of claim 1 wherein said composite material in said forming step is prepared from a plurality of sheets each of which is formed by a wet lay process, and wherein said plurality of sheets are stacked and molded together.

8. The method of claim 7 wherein said composite material includes a second polymer different from said thermoplastic polymer on at least one of the top of said stack and bottom of said stack.

9. The method of claim 8 further comprising adding graphite particles to said stack.

10. The method of claim 9 wherein the composition of said second polymer and said graphite particles is approximately 20 wt % and approximately 80 wt %, respectively.

11. The method of claim 9 wherein the ratio of said second polymer and graphite particles on the top of said stack:stack:said second polymer and graphite particles on the bottom of said stack is 1:1:1.

12. The method of claim 1 wherein said forming and molding step occur simultaneously or sequentially.

13. The method of claim 1 wherein said composite material produced in said forming step includes a first polymer in a core of said composite material and a second polymer, different from said first polymer, on a surface of said core.

14. A composite material, comprising:
60-80 wt % graphite particles;
thermoplastic at 10 to 30 wt %; and
reinforcing fibers at 1 to 20 wt %,
wherein the composite has one or more of the following attributes:
bulk conductivity is at least 150 S/cm,
through-plane conductivity of at least 10 S/cm, and
half cell resistance ranging from 0.03 to 0.003 ohm-cm²

15. The composite material of claim 14 wherein the bulk conductivity is at least 200 S/cm or the through plane conductivity ranges from 20-80 S/cm, or the half cell resistance is less than 0.02 ohm-cm²

16. The composite material of claim 14 wherein said composite material is formed in the shape of a bipolar plate.

17. The composite material of claim 14 wherein said bipolar plate has features molded into at least one surface.

18. The composite material of claim 14 wherein the tensile strength is at least 30 MPa.

19. The composite material of claim 14 wherein the flexural strength is at least 45 MPa.

20. The composite material of claim 14 wherein the thermoplastic includes more than one polymeric material.

21. The composite material of claim 20 wherein a first polymer is present in a core of said composite material, and a second polymer, different from said first polymer, is present on a surface of said core.

22. The composite material of claim 21 wherein said first polymer is polyethylene terephthalate, and said second polymer is polyvinyldifluoride.

23. A fuel cell bipolar plate, comprising:
a core of wet-lay composite material; and
a plurality of spaced apart ribs protruding from at least one side of said core, wherein said spaced apart teeth are formed from a polymer and graphite powders.

24. The fuel cell bipolar plate of claim 1 wherein said plurality of spaced apart ribs are positioned on a second side of said core opposite said at least one side of said core.
